(19) United States
(12) Patent Application Publication
(10) Pub. No.: US 2024/0331376 A1
(43) Pub. Date: Oct. 3, 2024

(54) METHOD, APPARATUS, STORAGE MEDIUM AND ELECTRONIC DEVICE FOR DETERMINING ALTERNATE LANDING AREA

(71) Applicant: AUTEL ROBOTICS CO., LTD., Shenzhen (CN)

(72) Inventor: Xueying JING, Shenzhen (CN)

(21) Appl. No.: 18/622,367

(22) Filed: Mar. 29, 2024

(30) Foreign Application Priority Data
Mar. 31, 2023 (CN) 202310379711.3

(51) Int. Cl. G06V 20/17; B64D 45/04; G06T 7/62; G06T 7/70; G06V 10/26; G06V 10/74; G06V 20/58

(52) U.S. Cl. CPC G06V 20/17; B64D 45/04; G06T 7/62; G06T 7/70; G06V 10/26; G06V 10/74; G06V 20/58; G06T 2207/10032; G06T 2207/30261

(57) ABSTRACT

The present disclosure discloses a method, apparatus, storage medium, and electronic device for determining an alternate landing area. The method for determining the alternate landing area includes: in the case where an aircraft receives an alternate landing mission, acquiring image data of an alternate landing area selected for the aircraft; performing image segmentation on the image data via a segmentation model to obtain an object element in the alternate landing area; and matching the object element with an element in a model library, and determining an occupancy state of the alternate landing area according to the matching result, wherein the model library includes the element and annotation information corresponding to the element.

### CROSS REFERENCE TO RELATED APPLICATION

This application claims priority to and the benefit of Chinese Patent Application No. 202310379711.3, filed Mar. 31, 2023, and titled “METHOD, APPARATUS, STORAGE MEDIUM AND ELECTRONIC DEVICE FOR DETERMINING ALTERNATE LANDING AREA,” the entirety of which is hereby incorporated by reference.

### BACKGROUND

At present, when aircraft such as aircraft and drones are unable or unsuitable to fly to the scheduled landing area or unable to land in the scheduled landing area, they need to land in other landing areas. Common reasons include air traffic control, deviation inability caused by large thunderstorms, and closure of the scheduled landing area.

In order to ensure flight safety, the aircraft's corresponding alternate landing area is determined before each takeoff. Generally speaking, if an aircraft needs to make an alternate landing within a short period of time after the takeoff, in most cases, it will choose to return to the area where it took off. When the aircraft completes one-half of the full range, the alternate landing may be selected in a certain area near the middle of the route that meets the aircraft's travel standards. If the aircraft has already arrived at the destination area, the alternate landing area may be selected in a certain area near the scheduled landing area, taking into account whether it meets the aircraft's flight standards, such as whether the alternate landing area is occupied or similar conditions.

In related technologies, due to the fact that the alternate landing area is a landing area without any monitoring equipment, it is only possible to manually determine whether the alternate landing area is occupied at present.

There is currently no effective solution to the problem of low efficiency in determining whether the alternate landing area is occupied through human intervention in related technologies.

### SUMMARY

The present disclosure relates to the field of aircraft control and, in particular, to a method, apparatus, storage medium, and electronic device for determining an alternate landing area.

An embodiment of the present disclosure provides a method, apparatus, storage medium, and electronic device for determining an alternate landing area, that is possible to effectively monitor whether an aircraft's alternate landing area is occupied and improve the effectiveness of surveying the aircraft's alternate landing area.

According to a first aspect of the present disclosure, some embodiment provided is a method for determining an alternate landing area including in the case where an aircraft receives an alternate landing mission, acquiring image data of an alternate landing area selected for the aircraft; performing image segmentation on the image data via a segmentation model to obtain an object element in the alternate landing area; and matching the object element with an element in a model library, and determining an occupancy state of the alternate landing area according to the matching result, wherein the model library includes: the element and annotation information corresponding to the element.

According to a second aspect of the present disclosure, also provided is an apparatus for determining an alternate landing area, including: an acquisition module configured to acquire, in the case where an aircraft receives an alternate landing mission, image data of an alternate landing area selected for the aircraft; a first determination module configured to perform image segmentation on the image data via a segmentation model to obtain an object element in the alternate landing area; and a second determination module configured to match the object element with an element in a model library, and determine an occupancy state of the alternate landing area according to the matching result, wherein the model library includes: the element and annotation information corresponding to the element.

According to yet another embodiment of the present disclosure, provided is a computer-readable storage medium, characterized in that the computer-readable storage medium includes a program stored therein that executes the method for determining the alternate landing area described above.

According to yet another embodiment of the present disclosure, also provided is an electronic device including memory, a processor, and a computer program stored in the memory and executable on the processor, wherein the processor executes the method for determining the alternate landing area by means of the computer program.

### BRIEF DESCRIPTION OF THE DRAWINGS

The accompanying drawings described here are intended to provide a further understanding of the present disclosure and form a part of the present application. The exemplary embodiment and their explanations of the present disclosure are used to explain the present disclosure and do not constitute an improper limitation of the present disclosure. In the drawings:

FIG. 1 is a hardware structure block diagram of a computer terminal in an embodiment of the present application;

FIG. 2 is a flowchart of a method for determining an optional alternate landing area according to an embodiment of the present disclosure;

FIG. 3 is a schematic diagram of the determination of an optional alternate landing area according to an embodiment of the present disclosure; and

FIG. 4 is a schematic diagram of functional modules of an apparatus for determining an optional alternate landing area according to an embodiment of the present disclosure.

### DETAILED DESCRIPTION

In order to enable personnel in this technical field to better understand the present application scheme, the technical solutions in the embodiments of the present application will be described clearly and completely in conjunction with the accompanying drawings in the embodiments of the present application. Obviously, the described embodiments are only a part of the embodiments of the present application, rather than all the embodiments. Based on the embodiments in the present application, all the other embodiments obtained by a person of ordinary skill in the art without manufacturing any inventive effort shall fall within the scope of protection of the present application.

It is noted that the terms “first”, “second”, and the like in the description, claims, and the aforementioned figures of the application, are used for distinguishing between similar objects and not necessarily for describing a particular sequential or chronological order. It is to be understood that the data used in this way are interchangeable under appropriate circumstances such that the embodiments of the application described herein are capable of operation in sequences other than those illustrated or otherwise described herein. Furthermore, the terms “comprise” and “have”, as well as any variations thereof, are intended to cover a non-exclusive inclusion, such that a process, method, system, product, or device that comprises a list of steps or elements is not necessarily limited to those steps or elements expressly listed, but may include other steps or elements not expressly listed or inherent to such process, method, product, or device.

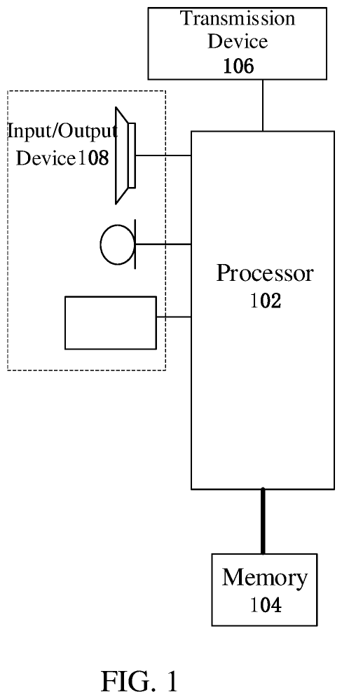

A method embodiment provided by an embodiment of the present application may be implemented in a computer terminal or similar computing apparatus. Taking running on a computer terminal as an example, FIG. 1 is a hardware structure block diagram of a computer terminal for determining an alternate landing area in an embodiment of the present application. As shown in FIG. 1, a computer terminal may include one or more (only one shown in FIG. 1) processors 102 (which may include, but are not limited to, processing apparatuses such as a microprocessor MCU or a programmable logic device FPGA) and a memory 104 for storing data. In an exemplary embodiment, the computer terminal described above may also include a transmission device 106 for allowing communication functions and an input/output device 108. It will be understood by those of ordinary skill in the art that the configuration shown in FIG. 1 is merely illustrative and does not limit the configuration of the computer terminal described above. For example, a computer terminal may also include more or fewer components than shown in FIG. 1, or have a different configuration with equivalent or more functions than shown in FIG. 1.

The memory 104 may be configured to store a computer program, for example, a software program and modules of an application software, such as a computer program corresponding to the method for determining an alternate landing area in the embodiment of the present application. The processor 102 executes the computer program stored in the memory 104 so as to perform various functional applications and data processing, i.e. to implement the above-mentioned method. The memory 104 may include a high-speed random access memory and may also include a non-volatile memory, such as one or more magnetic storage apparatuses, flash memory, or other non-volatile solid-state memory. In some examples, memory 104 may further include a memory remotely located with respect to the processor 102, which may be connected to the computer terminal via a network. Examples of such networks include, but are not limited to, the Internet, intranets, local area networks, mobile communication networks, and combinations thereof.

The transmission device 106 is configured to receive or transmit data via a network. Specific examples of the networks described above may include wireless networks provided by communication providers of computer terminals. In an embodiment, the transmission device 106 includes a Network Interface Controller (NIC) that may be connected to other network devices through a base station to communicate with the Internet. In an embodiment, the transmission device 106 may be a Radio Frequency (RF) module configured to communicate wirelessly with the Internet.

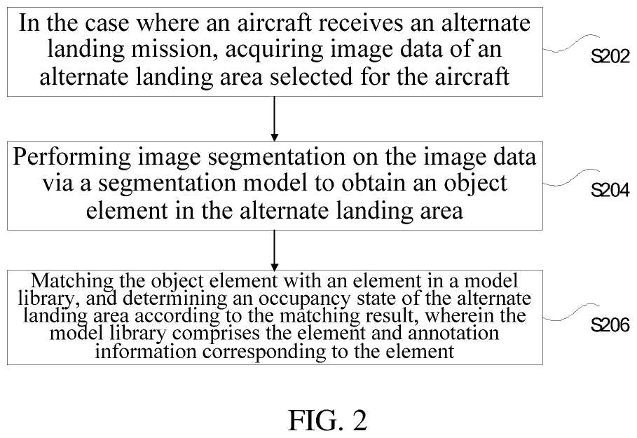

In the present embodiment, provided is a method for determining an alternate landing area applied to the above-mentioned computer terminal. FIG. 2 is a flow chart of a method for determining an alternate landing area according to an embodiment of the present application, and the flow chart includes the following steps:
S202, in the case where an aircraft receives an alternate landing mission, acquiring image data of an alternate landing area selected for the aircraft.

It needs to be stated that the image data of the alternate landing area can be captured by an image sensor of a pan-tilt. Specifically, when the distance between the aircraft and the alternate landing area is less than a preset distance, the image sensor of the pan-tilt faces the alternate landing area, captures the image data of the alternate landing area, synchronizes video streaming to a command center, and displays a picture.

It should be noted that the platform in the present application is a background monitoring system with the main functions of flight task management, flight control, remote live broadcast, and team management. A flight end uploads flight data and video to a command center via a ground control end. A backend user acquires real-time information about an unmanned aerial vehicle and manages relevant data via the command center.
S204, performing image segmentation on the image data via a segmentation model to obtain an object element in the alternate landing area.

It should be noted that the above-mentioned segmentation models include, but are not limited to a semantic segmentation model and an instance segmentation model.

The segmentation model can select a threshold value according to the overall or partial information of the image, divide the image according to the gray level, set the gray value of the pixel point to 1 when it is higher than the threshold value, and set it to 0 when it is lower than the threshold value, and in turn, separate an image of interest from the background.
S206, matching the object element with an element in a model library, and determining an occupancy state of the alternate landing area according to the matching result, wherein the model library includes the element and annotation information corresponding to the element.

It should be noted that the occupancy state includes an occupied state and an unoccupied state, wherein the occupied state includes a partially occupied state and a fully occupied state.

The above-described embodiment is implemented by: in the case where an aircraft receives an alternate landing mission, acquiring image data of an alternate landing area selected for the aircraft; performing image segmentation on the image data via a segmentation model to obtain an object element in the alternate landing area; and matching the object element with an element in a model library, and determining an occupancy state of the alternate landing area according to the matching result, wherein the model library includes: the element and annotation information corresponding to the element. In an embodiment of the present disclosure, by comparing image data of an alternate landing area with object elements in a model library to determine whether the alternate landing area is occupied, sending an early warning in advance or automatically executing a hovering of the aircraft according to a scheme of the aircraft during the alternate landing, the safety, and controllability of an aircraft can be ensured, the cost of human investigation can also be reduced, improving the effectiveness of surveying the aircraft’ alternate landing area, thereby solving the technical problem of low efficiency in the related art that whether the alternate landing area is occupied can only be determined manually.

In an exemplary embodiment, determining the occupancy state of the alternate landing area according to the matching result includes: in the case where the matching result indicates that the object element matches the element in the model library, determining that the occupancy state of the alternate landing area is an occupied state, wherein the occupied state includes: a partially occupied state and a fully occupied state; and in the case where the matching result indicates that the object element does not match the element in the model library, determining that the occupancy state of the alternate landing area is an unoccupied state.

That is, the object element in the image data is compared with the element in the model library (the element includes but is not limited to a person, a vehicle, a plant, a stone, a device, and an object) so as to determine whether the object element in the image data and the element in the model library have an overlap. In the case where the object element in the image data and the element in the model library have an overlap, the occupancy state of the alternate landing area is determined to be the occupied state; and in the case where the object element in the image data and the element in the model library have no overlap, the occupancy state of the alternate landing area is determined to be the unoccupied state.

Furthermore, in the case where the matching result indicates that the object element matches the element in the model library, the occupancy state of the alternate landing area is determined to be the partially occupied state or the fully occupied state according to the following manner: determining an area of the object element and an area of the alternate landing area; determining a ratio of the area of the object element and the area of the alternate landing area; and determining the occupancy state of the alternate landing area to be the partially occupied state or the fully occupied state according to the ratio.

That is to say, according to the ratio of the area of the object element occupying the area of the alternate landing area, the occupancy state of the alternate landing area is determined to be the partially occupied state or the fully occupied state. Specifically, in the case where the ratio is less than a preset threshold value, the occupancy state of the alternate landing area is determined to be the partially occupied state; and in the case where the ratio is greater than or equal to the preset threshold value, the occupancy state of the alternate landing area is determined to be the fully occupied state.

For example, in the case where the preset threshold value is 60% when the ratio of the area of the object element to the area of the alternate landing area is greater than or equal to 60%, the occupancy state of the alternate landing area is determined to be the fully occupied state; and when the ratio of the area of the object element to the area of the alternate landing area is less than 60%, the occupancy state of the alternate landing area is determined to be the partially occupied state.

Furthermore, in the case where the matching result indicates that the object element matches the element in the model library, the occupancy state of the alternate landing area is determined to be the partially occupied state or the fully occupied state according to the following manner: dividing the alternate landing area into a plurality of sub-alternate landing areas; determining a target sub-alternate area where the object element exists in the plurality of sub-alternate areas; determining the ratio of the value of the target sub-alternate area to the value of the multiple sub-alternate areas; and determining the occupancy state of the alternate landing area to be the partially occupied state or the fully occupied state according to the ratio.

Specifically, in the case where the ratio is less than a preset threshold value, the occupancy state of the alternate landing area is determined to be the partially occupied state; and in the case where the ratio is greater than or equal to the preset threshold value, the occupancy state of the alternate landing area is determined to be the fully occupied state.

Optionally, in the case where the occupancy state of the alternate landing area is the partially occupied state, a suitable landing position can be recalculated and adjusted; and in the case where the occupancy state of the alternate landing area is the fully occupied state, it is determined that the aircraft cannot land in the alternate landing area.

Optionally, in the case where the occupancy state of the alternate landing area is determined to be the partially occupied state, determining a landing area by the following manners: determining a position and an area of the object element; determining a position of a continuous free area in the alternate landing area and an area of the continuous free area according to the position and the area of the object element; and in the case where the area of the continuous free area is greater than a preset area, determining a landing area of the aircraft according to the position of the continuous free area, wherein the preset area is a footprint area that can be covered when the aircraft lands.

In an embodiment of the present disclosure, the determined landing area is a continuous area, rather than a scattered area. In the case where the area of a continuous free area is greater than a preset area, it is determined that the continuous free area can be used as the landing area of the aircraft; otherwise, in the case where the area of the continuous free area is less than or equal to the preset area, or in the case where the area of the scattered free area is greater than the preset area, it is determined that the free area cannot be used as the landing area of the aircraft, thereby achieving the technical effect of accurately determining the landing area.

In an exemplary embodiment, acquiring image data of an alternate landing area selected for the aircraft includes: acquiring a distance between the aircraft and the alternate landing area in real-time; in the case where the distance is less than a preset threshold value, determining a resolution of an image sensor located in the alternate landing area according to the distance; and controlling the image sensor to collect image data of the alternate landing area based on the resolution.

That is to say, in the case where the distance between the aircraft and the alternate landing area is less than the preset threshold value, the image data of the alternate landing area is acquired by the image sensor, thereby reducing the power consumption of the image sensor, allowing the effect of reducing resource usage.

Furthermore, there is a corresponding relationship between the resolution of the image sensor in the embodiment of the present disclosure and the distance between the aircraft and the alternate landing area, where the distance is inversely proportional to the resolution. Specifically, the larger the distance, the lower the resolution.

In an exemplary embodiment, prior to acquiring image data of an alternate landing area selected for the aircraft, it further includes: acquiring a list of alternate landing areas of the aircraft, wherein the list of alternate landing areas includes a plurality of alternate landing areas, wherein the state of any one of the plurality of alternate landing areas is an available state; determining a distance between each alternate landing area and the aircraft; and determining an alternate landing area with the minimum distance as the alternate landing area of the aircraft from the plurality of distances.

That is, the alternate landing area in an embodiment of the disclosure is the area in the list of alternate landing areas that is closest to the distance of the aircraft.

In order to better understand the process of the method for determining the above-mentioned alternate landing area, the flow of the method for achieving the above-mentioned determination of the alternate landing area is described below in conjunction with alternative embodiments but is not intended to limit the technical solution of the embodiments of the present application.

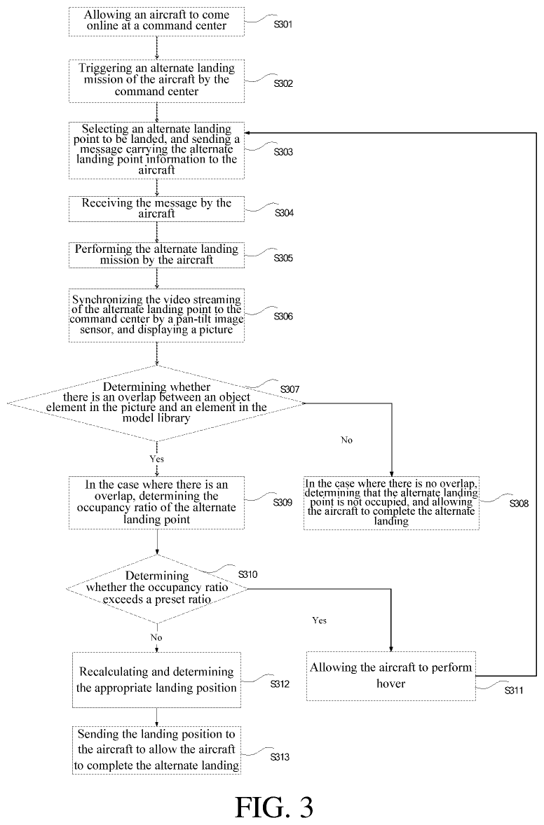

In the present embodiment, provided is a method for determining an alternate landing area. FIG. 3 is a schematic diagram of the determination of an optional alternate landing area according to an embodiment of the present disclosure. As shown in FIG. 3, the specific steps are as follows:
Step S301: allowing the aircraft to come online at a command center;
when an aircraft is online at the command center, synchronously displaying a video streaming corresponding to the aircraft to a display screen of the command center;
Step S302: triggering an alternate landing mission of the aircraft by the command center;
Step S303: selecting an alternate landing point to be landed, and sending a message carrying the alternate landing point information to the aircraft;
Step S304: receiving the message by the aircraft;
Step S305: performing the alternate landing mission by the aircraft;
Step S306: flying the aircraft to the alternate landing point (equivalent to the alternate landing area in the above-mentioned embodiment), and when the distance between the aircraft and the alternate landing point is less than a preset distance, allowing the pan-tilt image sensor to start to face the alternate landing point, synchronizing a video streaming of the alternate landing point to the command center, and displaying a picture;
Step S307: synchronously comparing an object element in the picture with an element in a model library (a person, a vehicle, a plant, a stone, a device, an object, etc.) so as to determine whether there is an overlap between the object element of the alternate landing point and the element in the model library;
Step S308: in the case where there is no overlap, determining that the alternate landing point is not occupied, and allowing the aircraft to complete the alternate landing;
Step S309: in the case where there is an overlap, determining the occupancy ratio of the alternate landing point;
Step S310: determining whether the occupancy ratio exceeds a preset ratio;
Step S311: in the case where the occupancy ratio exceeds the preset ratio, allowing the aircraft to execute hovering and wait for the next instruction; and in the case where the command center acquires a new alternate landing point, executing Step S303-Step S310 again;
Step S312: in the case where the occupancy ratio does not exceed the preset ratio, recalculating and determining a suitable landing position according to the occupied condition; and
Step S313: sending the landing position to the aircraft to allow the aircraft to complete the alternate landing.

It should be noted that, in the case where the occupancy ratio exceeds the preset ratio, an alarm message is displayed to the command center, so that the command center confirms the alarm message and sends the command to execute the hovering operation to the aircraft.

It should be noted that the model library provides preset data information such as people, vehicles, plants, stones, devices, objects, etc., and provides comparison templates for intelligent comparison. The model library can gradually enrich the types of models and improve the detailed information of models through continuous comparison of information, and deep learning makes automatic annotation more accurate. The command center supports the user in managing the setting of the alternate landing point available/disabled state.

With the above embodiment, it is predicted whether the alternate landing point is occupied before the landing, reducing the cost of human surveying and confirmation. Whether the alternate landing point is occupied can be intelligently determined, and an algorithm can be preset and executed in advance, improving the accuracy rate of the aircraft's alternate landing.

In an exemplary embodiment, determining the occupancy state of the alternate landing area according to the matching result includes: in the case where the matching result indicates that the object element matches the element in the model library, determining that the occupancy state of the alternate landing area is an occupied state, wherein the occupied state includes: a partially occupied state and a fully occupied state; and in the case where the matching result indicates that the object element does not match the element in the model library, determining that the occupancy state of the alternate landing area is an unoccupied state.

In an exemplary embodiment, determining the occupancy state of the alternate landing area according to the matching result includes: in the case where the matching result indicates that the object element matches the element in the model library, determining an area of the object element and an area of the alternate landing area; determining a ratio of the area of the object element and the area of the alternate landing area; and determining the occupancy state of the alternate landing area as a partially occupied state or a fully occupied state according to the ratio.

In an exemplary embodiment, determining the occupancy state of the alternate landing area according to the ratio includes: in the case where the ratio is less than a preset threshold value, determining that the occupancy state of the alternate landing area is the partially occupied state; and in the case where the ratio is greater than or equal to the preset threshold value, determining that the occupancy state of the alternate landing area is the fully occupied state.

In an exemplary embodiment, the method further includes: in the case where the occupancy state of the alternate landing area is determined to be the partially occupied state, determining the position and area of the object element; determining a position of a continuous free area in the alternate landing area and an area of the continuous free area according to the position and the area of the object element; and in the case where the area of the continuous free area is greater than a preset area, determining a landing area of the aircraft according to the position of the continuous free area, wherein the preset area is a footprint area that can be covered when the aircraft lands.

In an exemplary embodiment, acquiring image data of the alternate landing area selected for the aircraft includes: acquiring a distance between the aircraft and the alternate landing area in real-time; in the case where the distance is less than a preset threshold value, determining a resolution of an image sensor located in the alternate landing area according to the distance; and controlling the image sensor to collect image data of the alternate landing area based on the resolution.

In an exemplary embodiment, the method further includes: acquiring a list of alternate landing areas of the aircraft, wherein the list of alternate landing areas includes a plurality of alternate landing areas, wherein the state of any one of the plurality of alternate landing areas is an available state; determining a distance between each alternate landing area and the aircraft; and determining an alternate landing area with the minimum distance as the alternate landing area of the aircraft from the plurality of distances.

It should be noted that for the above-mentioned embodiments of each method, for the sake of simplicity, they are all expressed as a series of action combinations. However, those skilled in the art should be aware that the present disclosure is not limited by the order of the described actions, as according to the present disclosure, certain steps can be performed in other sequences or simultaneously. Secondly, a person skilled in the art would also know that the embodiments described in the description are all preferred embodiments, and the actions and modular involved are not necessarily required by the present disclosure.

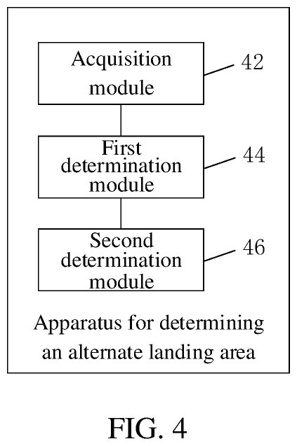

According to another aspect of an embodiment of the present disclosure, also provided is an apparatus for determining an alternate landing area for implementing the above-mentioned method for determining an alternate landing area. As shown in FIG. 4, which is a schematic diagram of the functional modules of an apparatus for determining an optional alternate landing area according to an embodiment of the present disclosure, the apparatus includes:
an acquisition module 42 configured to acquire, in the case where an aircraft receives an alternate landing mission, image data of an alternate landing area selected for the aircraft;
a first determination module 44 configured to perform image segmentation on the image data via a segmentation model to obtain an object element in the alternate landing area; and
a second determination module 46 configured to match the object element with an element in a model library, and determine an occupancy state of the alternate landing area according to the matching result, wherein the model library includes the element and annotation information corresponding to the element.

The above-described device is implemented by: in the case where an aircraft receives an alternate landing mission, acquiring image data of an alternate landing area selected for the aircraft; performing image segmentation on the image data via a segmentation model to obtain an object element in the alternate landing area; and matching the object element with an element in a model library, and determining an occupancy state of the alternate landing area according to the matching result, wherein the model library includes: the element and annotation information corresponding to the element. By comparing image data of an alternate landing area with object elements in a model library to determine whether the alternate landing area is occupied, sending an early warning in advance or automatically executing a hovering of the aircraft according to a scheme of the aircraft during the alternate landing, the safety and controllability of the device can be ensured, the cost of human investigation can also be reduced, thereby solving the technical problem of low efficiency in the related art that whether the alternate landing area is occupied can only be determined manually.

In an exemplary embodiment, a second determination module 46 is configured to determine, in the case where the matching result indicates that the object element matches the element in the model library, that the occupancy state of the alternate landing area is an occupied state, wherein the occupied state includes a partially occupied state and a fully occupied state; and in the case where the matching result indicates that the object element does not match the element in the model library, determine that the occupancy state of the alternate landing area is the unoccupied state.

In an exemplary embodiment, a second determination module 46 is configured to determine, in the case where the matching result indicates that the object element matches the element in the model library, an area of the object element and an area of the alternate landing area; determine a ratio of the area of the object element and the area of the alternate landing area; and determine the occupancy state of the alternate landing area to be the partially occupied state or the fully occupied state according to the ratio.

In an exemplary embodiment, a second determination module 46 is configured to determine, in the case where the ratio is less than the preset threshold value, the occupancy state of the alternate landing area to be the partially occupied state; and in the case where the ratio is greater than or equal to the preset threshold value, determine that the occupancy state of the alternate landing area to be the fully occupied state.

In an exemplary embodiment, a second determination module 46 is configured to determine, in the case where the occupancy state of the alternate landing area is determined to be the partially occupied state, the position, and area of the object element; determine a position of a continuous free area in the alternate landing area and an area of the continuous free area according to the position and the area of the object element; and determine, in the case where the area of the continuous free area is greater than a preset area, the landing area of the aircraft according to the position of the continuous free area, wherein the preset area is a footprint area that can be covered when the aircraft lands.

In an exemplary embodiment, an acquisition module 42 is configured to acquire the distance between the aircraft and the alternate landing area in real-time; in the case where the distance is less than the preset threshold value, determine the resolution of the image sensor located in the alternate landing area according to the distance; and control the image sensor to collect image data of the alternate landing area based on the resolution.

In an exemplary embodiment, an acquisition module 42 is configured to acquire a list of alternate landing areas of the aircraft, wherein the list of alternate landing areas includes a plurality of alternate landing areas, and the state of any one of the plurality of alternate landing areas is an available state; determine a distance of each alternate landing zone from the aircraft; and determine, from a plurality of distances, an alternate landing area with the minimum distance as the alternate landing area of the aircraft.

A specific embodiment may refer to the example shown in the above-mentioned method for determining an alternate landing area, which will not be described in detail herein.

Optionally, in this embodiment, the electronic device may be located in at least one of a plurality of network devices of a computer network.

Optionally, in this embodiment, the processor may be arranged to perform the following steps by a computer program:
in the case where an aircraft receives an alternate landing mission, acquiring image data of an alternate landing area selected for the aircraft;
performing image segmentation on the image data via a segmentation model to obtain an object element in the alternate landing area; and
matching the object element with an element in a model library, and determining an occupancy state of the alternate landing area according to the matching result, wherein the model library includes the element and annotation information corresponding to the element.

In an embodiment, the terminal device or the server may be a node in a distributed system, wherein the distributed system may be a blockchain system, and the blockchain system may be a distributed system formed by connecting the plurality of nodes via network communication. The nodes can form a Peer-To-Peer (P2P) network, and any type of computing devices, such as servers, terminals, and other electronic devices, can be a node in the blockchain system by joining the peer-to-peer network.

According to one aspect of the present application, provided is a computer program product including a computer program/instructions containing program code for performing the method shown in the flowchart. In such embodiments, the computer program may be downloaded and installed from the network and/or from a removable medium via a communications portion. The computer program, when executed by a central processor, performs the various functions provided by the embodiments of the present application.

The above-mentioned serial numbers of the embodiments of the present disclosure are merely for the purpose of description and do not represent the advantages and disadvantages of the embodiments.

It should be noted that the computer system of the electronic device is only one example and should not impose any limitation on the scope of use or function of the embodiments of the present application.

The computer system includes a central processing unit (CPU) which can perform various appropriate actions and processes according to a program stored in a read-only memory (ROM) or a program loaded from a storage section into a random access memory (RAM). In the random access memory, various programs and data required for the operation of the system are also stored. The CPU, ROM, and RAM are connected to each other via a bus. An input/output interface (I/O interface) is also connected to the bus.

The following components are connected to the I/O interface: an input portion including a keyboard, a mouse, etc.; an output portion including a cathode ray tube (CRT), a liquid crystal display (LCD), and a loudspeaker, etc.; a storage portion including a hard disk, etc.; and a communication portion including a network interface card such as a local area network card, a modem, etc. The communication portion performs communication processing via a network such as the Internet. A driver is also connected to an input/output interface as required. A removable medium, such as a magnetic disk, optical disk, magneto-optical disk, semiconductor memory or the like, is mounted on the drive as required so that a computer program read therefrom is mounted into the storage portion as required.

In particular, the processes described in the various method flow diagrams may be implemented as computer software programs in accordance with the embodiments of the present application. For example, embodiments of the present application include a computer program product including a computer program embodied on a computer-readable medium, and the computer program including program codes for performing the method illustrated in the flowcharts. In such embodiments, the computer program may be downloaded and installed from the network and/or from a removable medium via a communications portion. The computer program, when executed by a CPU, performs the various functions defined in the system of the present application.

According to one aspect of the present application, provided is a computer-readable storage medium from which a processor of a computer device reads the computer instructions. The processor executes the computer instructions to cause the computer device to perform the method provided in the various alternative implementations described above.

Optionally, in this embodiment, the computer-readable storage medium described above may be arranged to store a computer program for performing the following steps:
in the case where an aircraft receives an alternate landing mission, acquiring image data of an alternate landing area selected for the aircraft;
performing image segmentation on the image data via a segmentation model to obtain an object element in the alternate landing area; and
matching the object element with an element in a model library, and determining an occupancy state of the alternate landing area according to the matching result, wherein the model library includes the element and annotation information corresponding to the element.

Optionally, in the present embodiment, a person of ordinary skill in the art would have been able to understand that all or part of the steps in the various methods of the above-mentioned embodiments can be performed by instructing the hardware related to the terminal device through a program, which can be stored in a computer-readable storage medium, including flash drive, Read Only Memory (ROM), Random Access Memory (RAM), disk or optical disc, etc.

An embodiment of the disclosure is implemented by: in the case where an aircraft receives an alternate landing mission, acquiring image data of an alternate landing area selected for the aircraft; performing image segmentation on the image data via a segmentation model to obtain an object element in the alternate landing area; and matching the object element with an element in a model library, and determining an occupancy state of the alternate landing area according to the matching result, wherein the model library includes the element and annotation information corresponding to the element. In an embodiment of the present disclosure, by comparing image data of an alternate landing area with the object element in the model library to determine whether the alternate landing area is occupied, sending an early warning in advance or automatically executing a hovering of the aircraft according to a scheme of the aircraft during the alternate landing, the safety, and controllability of an aircraft can be ensured, the cost of human conveying can also be reduced, thereby solving the technical problem of low efficiency in the related art that whether the alternate landing area is occupied can only be determined manually.

The above-mentioned serial numbers of the embodiments of the present disclosure are merely for the purpose of description and do not represent the advantages and disadvantages of the embodiments.

The integrated unit in the above embodiment, if implemented in the form of a software functional unit and sold or used as a stand-alone product, may be stored in the computer-readable storage medium described above. Based on such an understanding, the technical solution of the present disclosure, either per se or in part contributing to the prior art, or all or part of the technical solution, may be embodied in the form of a software product stored in a storage medium including instructions for causing one or more computer device (which may be a personal computer, a server, or a network device, etc.) to perform all or part of the steps of the method according to various embodiments of the present disclosure.

Various functional units in various embodiments of the present disclosure may be integrated into one processing unit, may exist physically in a single unit, or may be integrated into one unit in two or more units. The above-mentioned integrated units may be implemented in the form of hardware or in the form of software functional units.

The above are only the preferred embodiments of the present disclosure. It should be pointed out that for ordinary technical personnel in this field, several improvements and embellishments can be made without departing from the principle of the present disclosure. These improvements and embellishments should also be considered as the scope of protection of the present disclosure.

What is claimed is:

1. A method for determining an alternate landing area, comprising:
acquiring image data of an alternate landing area selected for the aircraft when an aircraft receives an alternate landing mission,
performing image segmentation on the image data with a segmentation model, obtaining an object element within the alternate landing area; and
matching the object element with elements in a model library, and determining an occupancy state of the alternate landing area according to a matching result, wherein the model library comprises the elements and annotation information corresponding to the elements.

2. The method according to claim 1, wherein the determining the occupancy state of the alternate landing area according to the matching result comprises:
determining that the occupancy state of the alternate landing area is an occupied state, when the matching result indicates that the object element matches the element in the model library, wherein the occupied state comprises: a partially occupied state and a fully occupied state; and
determining that the occupancy state of the alternate landing area is an unoccupied state when the matching result indicates that the object element does not match the element in the model library.

3. The method according to claim 1, wherein the determining the occupancy state of the alternate landing area according to the matching result comprises:
determining an area of the object element and an area of the alternate landing area, when the matching result indicates that the object element matches the element in the model library,
determining a ratio of the area of the object element and the area of the alternate landing area; and
determining the occupancy state of the alternate landing area as a partially occupied state or a fully occupied state according to the ratio.

4. The method according to claim 3, wherein the determining the occupancy state of the alternate landing area according to the ratio comprises:
determining that the occupancy state of the alternate landing area is the partially occupied state when the ratio is less than a preset threshold value, and
determining that the occupancy state of the alternate landing area is the fully occupied state when the ratio is greater than or equal to the preset threshold value.

5. The method according to claim 1, wherein the method further comprises:
when the occupancy state of the alternate landing area is determined to be the partially occupied state, determining the position and area of the object element;
determining a position of a continuous free area in the alternate landing area and an area of the continuous free area according to the position and the area of the object element; and
when the area of the continuous free area is greater than a preset area, determining a landing area of the aircraft according to the position of the continuous free area, wherein the preset area is a footprint area that can be covered when the aircraft lands.

6. The method according to claim 1, wherein the acquiring image data of the alternate landing area selected for the aircraft comprises:
acquiring a distance between the aircraft and the alternate landing area in real-time;
when the distance is less than a preset threshold value, determining a resolution of an image sensor located in the alternate landing area according to the distance; and
controlling the image sensor to collect image data of the alternate landing area based on the resolution.

7. The method according to claim 1, wherein the method further comprises:
acquiring a list of alternate landing areas of the aircraft, wherein the list of alternate landing areas comprises a plurality of alternate landing areas, wherein the state of any one of the plurality of alternate landing areas is an available state;
determining the distance between each alternate landing area and the aircraft; and
determining an alternate landing area with the minimum distance as the alternate landing area of the aircraft from the plurality of distances.

8. An apparatus for determining an alternate landing area, comprising:
an acquisition module configured to acquire image data of an alternate landing area selected for the aircraft when receives an alternate landing mission;
a first determination module configured to perform image segmentation on the image data via a segmentation model to obtain an object element in the alternate landing area; and
a second determination module configured to match the object element with an element in a model library and determine an occupancy state of the alternate landing area according to a matching result, wherein the model library comprises the element and annotation information corresponding to the element.

9. The apparatus according to claim 8, wherein the second determination module is further configured to:
determine that the occupancy state of the alternate landing area is an occupied state, when the matching result indicates that the object element matches the element in the model library, wherein the occupied state comprises: a partially occupied state and a fully occupied state; and
determine that the occupancy state of the alternate landing area is an unoccupied state when the matching result indicates that the object element does not match the element in the model library.

10. The apparatus according to claim 8, wherein the second determination module is further configured to:
determine an area of the object element and an area of the alternate landing area, when the matching result indicates that the object element matches the element in the model library,
determine a ratio of the area of the object element and the area of the alternate landing area; and
determine the occupancy state of the alternate landing area as a partially occupied state or a fully occupied state according to the ratio.

11. The apparatus according to claim 9, wherein the second determination module is further configured to:
determining that the occupancy state of the alternate landing area is the partially occupied state when the ratio is less than a preset threshold value, and
determining that the occupancy state of the alternate landing area is the fully occupied state when the ratio is greater than or equal to the preset threshold value.

12. The apparatus according to claim 11, wherein the second determination module is further configured to:
when the occupancy state of the alternate landing area is determined to be the partially occupied state, determine the position and area of the object element;
determine a position of a continuous free area in the alternate landing area and an area of the continuous free area according to the position and the area of the object element; and
when the area of the continuous free area is greater than a preset area, determine a landing area of the aircraft according to the position of the continuous free area, wherein the preset area is a footprint area that can be covered when the aircraft lands.

13. The apparatus according to claim 11, wherein the second determination module is further configured to:
acquire a distance between the aircraft and the alternate landing area in real-time;
when the distance is less than a preset threshold value, determine a resolution of an image sensor located in the alternate landing area according to the distance; and
control the image sensor to collect image data of the alternate landing area based on the resolution.

14. The apparatus according to claim 11, wherein the second determination module is further configured to:
acquire a list of alternate landing areas of the aircraft, wherein the list of alternate landing areas comprises a plurality of alternate landing areas, wherein the state of any one of the plurality of alternate landing areas is an available state;
determine the distance between each alternate landing area and the aircraft; and
determine an alternate landing area with the minimum distance as the alternate landing area of the aircraft from the plurality of distances.

15. An electronic device comprising a memory and a processor, wherein the memory stores a computer program, and the processor is configured to execute a method for determining an alternate landing area, wherein the method comprising:
acquiring image data of an alternate landing area selected for the aircraft when an aircraft receives an alternate landing mission,
performing image segmentation on the image data with a segmentation model, obtaining an object element within the alternate landing area; and
matching the object element with elements in a model library, and determining an occupancy state of the alternate landing area according to a matching result, wherein the model library comprises the elements and annotation information corresponding to the elements.

16. The electronic device according to claim 15, wherein the determining the occupancy state of the alternate landing area according to the matching result comprises:
determining that the occupancy state of the alternate landing area is an occupied state, when the matching result indicates that the object element matches the element in the model library, wherein the occupied state comprises: a partially occupied state and a fully occupied state; and
determining that the occupancy state of the alternate landing area is an unoccupied state when the matching result indicates that the object element does not match the element in the model library.

17. The electronic device according to claim 15, wherein the determining the occupancy state of the alternate landing area according to the matching result comprises:
determining an area of the object element and an area of the alternate landing area, when the matching result indicates that the object element matches the element in the model library,
determining a ratio of the area of the object element and the area of the alternate landing area; and
determining the occupancy state of the alternate landing area as a partially occupied state or a fully occupied state according to the ratio.

18. The electronic device according to claim 17, wherein the determining the occupancy state of the alternate landing area according to the ratio comprises:
determining that the occupancy state of the alternate landing area is the partially occupied state when the ratio is less than a preset threshold value, and
determining that the occupancy state of the alternate landing area is the fully occupied state when the ratio is greater than or equal to the preset threshold value.

19. The electronic device according to claim 17, wherein the method further comprises:
when the occupancy state of the alternate landing area is determined to be the partially occupied state, determining the position and area of the object element;
determining a position of a continuous free area in the alternate landing area and an area of the continuous free area according to the position and the area of the object element; and
when the area of the continuous free area is greater than a preset area, determining a landing area of the aircraft according to the position of the continuous free area, wherein the preset area is a footprint area that can be covered when the aircraft lands.

20. The electronic device according to claim 1, wherein the acquiring image data of the alternate landing area selected for the aircraft comprises:
acquiring a distance between the aircraft and the alternate landing area in real-time;
when the distance is less than a preset threshold value, determining a resolution of an image sensor located in the alternate landing area according to the distance; and
controlling the image sensor to collect image data of the alternate landing area based on the resolution.
